(19) United States
(12) Patent Application Publication
(10) Pub. No.: US 2014/0376924 A1
(43) Pub. Date: Dec. 25, 2014

(54) SYSTEM AND METHOD FOR GENERATING OPTICAL OUTPUT FROM AN ELECTRONIC DEVICE

(71) Applicants: Alon Konchitsky, Santa Clara, CA (US); Amit Jacob Ronen, Mountain View, CA (US)

(72) Inventors: Alon Konchitsky, Santa Clara, CA (US); Amit Jacob Ronen, Mountain View, CA (US)

(21) Appl. No.: 13/925,159

(22) Filed: Jun. 24, 2013

(51) Int. Cl. H04B 10/50; H04R 1/10

(52) U.S. Cl. CPC H04B 10/50; H04R 1/10
USPC 398/182

(57) ABSTRACT

An optical processing system for an electronic device is provided. The optical processing system includes a digital component for generating digital signals based on received signals from the electronic device. The optical processing system further includes an optical component for generating optical signals based on the digital signals. The optical processing system further includes a transmit component for transmitting the generated optical signals to an earpiece. The earpiece includes a converter for converting the optical signals into electrical signals, and a speaker for converting the electrical signals to sound.

### BACKGROUND

1. Field of the Invention

Embodiments of the present invention relate to a system and method for generating optical output from an electronic device. More specifically, embodiments of the present invention relate to a system and method for optically coupling an earpiece with the electronic device.

2. Description of Related Art

Mobile phones have recently become integral part of our lives. The mobile phones produce a lot of radio frequency radiation during use. Further, the increased use of the mobile phones has caused a corresponding increase in exposure of low level radio frequency radiation to bodies of users. In particular, users of mobile phones are experiencing increased exposure in cranial area, because most of the mobile phones are designed to be held in close proximity to users' ears during use.

Conventional solutions for addressing above issues have been usage of earpiece (or headphone) and wireless earphones (or wireless headphones). However, earpiece and wireless earphones have been failed to solve above issue of radiation exposure to users. This is because of fact that the earpiece requires wires for connecting the earpiece with the mobile phone. The wires typically extend toward ears of users to facilitate reception of signals by users' ears and transmission of voice signals. The wires are inherently conductors of radio frequency radiation, and these wires typically act as antennas receiving and directing radio signal power into and around the cranial region of users. Hence, the earpiece does not, therefore, adequately decrease radio frequency radiation exposure to users of mobile phones. Further, signals flowing through such wires are susceptible to interference by nearby signals causing inconvenience for the users. Furthermore, signals following through such wires experience a lot of loss because of resistance of wires.

Wireless earphones have also been failed to solve above issue of radiation exposure to users. This is because of fact that wireless earphone or wireless headsets frequently employ radio frequency transmission to deliver signals to the ears of a user from a base mobile communication unit (e.g., a mobile phone). The wireless headsets typically provide advantage of reduced levels of radio frequency radiation at certain frequencies, as compared to radio frequency radiation levels produced by a typical base mobile communication unit. But, the same wireless headsets actually produce higher levels of radio frequency radiation than the typical base mobile communication unit at other frequencies. Further, wireless headsets are typically designed to be held in even closer physical proximity to a user's cranial region during use than the typical base mobile communication unit would be during use. Accordingly, the use of wireless headsets may actually increase radio frequency radiation exposure experienced by users of mobile communication devices.

Therefore, there is a need for a system and method that is capable of addressing above issues and ameliorating the radio frequency radiation exposure experienced by users and further making usages of the mobile phones easier and safer for the users.

### SUMMARY

Embodiments in accordance with the present invention provide an optical processing system for an electronic device. The optical processing system includes a digital component for generating digital signals based on received signals from the electronic device. The optical processing system further includes an optical component for generating optical signals based on the digital signals. The optical processing system further includes a transmit component for transmitting the generated optical signals to an earpiece.

Embodiments in accordance with the present invention further provide a computer-implemented method for generating optical signals at an electronic device. The computer-implemented method includes generating digital signals based on received signals from the electronic device, generating optical signals at the electronic device based on the digital signals, and transmitting the generated optical signals to an earpiece from the electronic device.

Further, the present invention can provide a number of advantages depending on its particular configuration. First, embodiments of the present invention provide a system and a method for reducing exposure of a user from radiation coming from a mobile phone by utilizing optical signals for transmission of signals from the mobile phones towards ear of the users. The optical signals are generated at the mobile device from the digital signals received at the mobile device. The optical signals are transmitted to the earpiece by utilizing an optical fiber cable that connects the mobile device with the earpiece and communicates the optical signals to the earpiece. Further, the present invention provides a technique for coupling the earphone with the mobile phone so that there is no interference associated with the signals transmitted from the mobile phone to the earpiece. Furthermore, the present invention provides a techniques so that there is no loss of signals (or less loss compared to analog signals) in the transmission from the mobile phone to the earpiece.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 is an exemplary block diagram depicting an electronic device connected with a headphone via an optical fiber, in accordance with an embodiment of the present invention;

FIG. 2 is an exemplary block diagram of an electronic device, in accordance with an embodiment of the present invention;

FIG. 3 is a block diagram of an optical processing system, in accordance with an embodiment of the present invention; and

FIG. 4 is a flow chart depicting a method for generating optical output from an electronic device, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The invention will be illustrated below in conjunction with a mobile device. Although well suited for use with any electronic device, e.g., desktop computer, laptop, etc., the invention is not limited to any particular type of electronic device. Those skilled in the art will recognize that the disclosed techniques may be used in any electronic or communication device.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine”, “calculate” and “compute,” and variations thereof, as used herein, are used interchangeably and include any type of methodology, process, mathematical operation or technique.

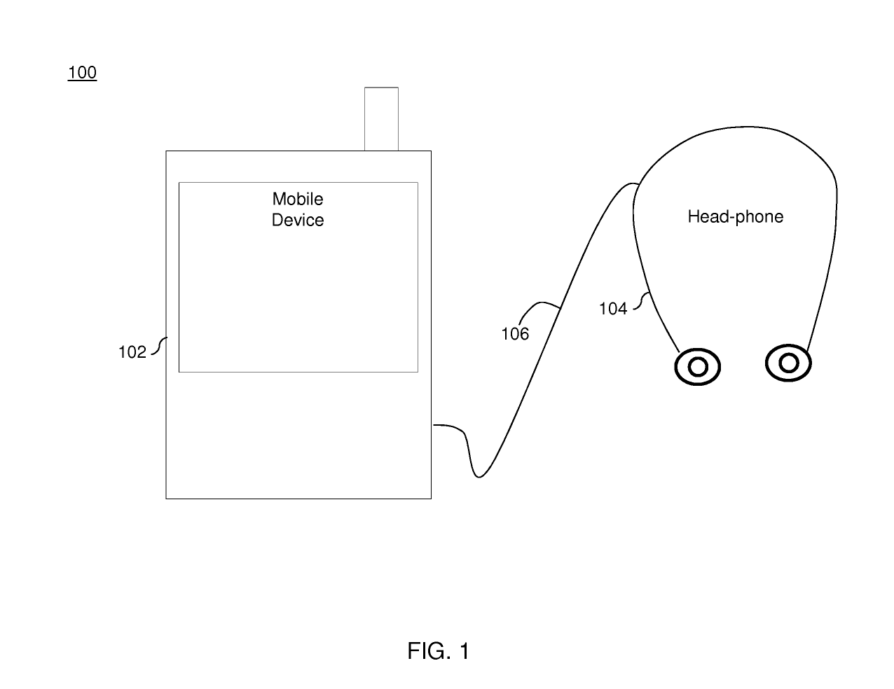

FIG. 1 illustrates an exemplary environment 100, where various embodiments of the present invention may be implemented. The environment 100 includes an electronic device 102 connected to an earpiece or head phone 104. In an embodiment of the present invention, the electronic device 102 is a mobile phone. In another embodiment of the present invention, the electronic device may be any other electronic device including, but not limited to, desktop computer, laptop etc. Further, according to an embodiment of the present invention, the electronic device 102 and the head-phone 104 are connected via an optical fiber cable 106.

Further, according to an embodiment of the present invention, the earpiece 104 includes a converter (not shown in the figure). The converter is configured to convert received optical signals to sound for the user. In an embodiment of the present invention, the converter includes an optical to electrical converter and a speaker. The optical to electrical converter may convert the received optical signals to electrical signals. The speaker may convert the electrical signals to sound.

In another embodiment of the present invention, the converter may include a photodiode, phototransistor, photo-darlington pair, or a similar element capable of converting an optical signal or photonic signal to an electrical signal. The earpiece 104 may amplify the electrical signal and transmit the signal to a sound producing diaphragm or earphone capable of producing sound within the audible range of a user. Likewise, the earpiece 104 may contain a battery to power the amplifier and other components contained within the device. Moreover, certain embodiments of the earpiece may include a volume control to conserve power when the acoustic signal falls below a certain threshold value.

Further, in an embodiment, the earpiece 104 may also include a microphone (now shown in the figure). The microphone may enable a user to provide speech input into the electronic device 102 via the earpiece 104 and the optical fiber cable 106. In another embodiment, the electronic device 102 may integrate, into a single integrated system, the earpiece 104 with a microphone for receiving acoustic signals. The signal from the microphone may use the same optical fiber as the earphone to transmit back to the mobile phone. The microphone may be configured to convert an acoustic impulse to an electrical signal and then to a photonic signal for transmission across the optical fiber 106. On receiving end, a detector may detect the photonic signal and convert it to an electrical signal to produce an input to the electronic device (e.g., mobile phone).

In another embodiment of the present invention, the electronic device 102 may be implemented so that no electrical signals are needed within the earpiece and microphone, eliminating the need for a battery within said pieces. This embodiment may eliminate substantially all radio frequency radiation exposure that may be caused by electrical signals within the earphone or microphone. In an embodiment, a laser diode may be used in a coupler connected to the electronic device 102 to transmit across an optical fiber and actuate a laser driven diaphragm located in the earpiece. A detector is also located in the coupler to detect displacements of a diaphragm (e.g., used as a microphone) through an optical fiber. In another embodiment, an optical coupler may also be used in the electronic device 102 to transmit the optical signals across the optical fiber 106.

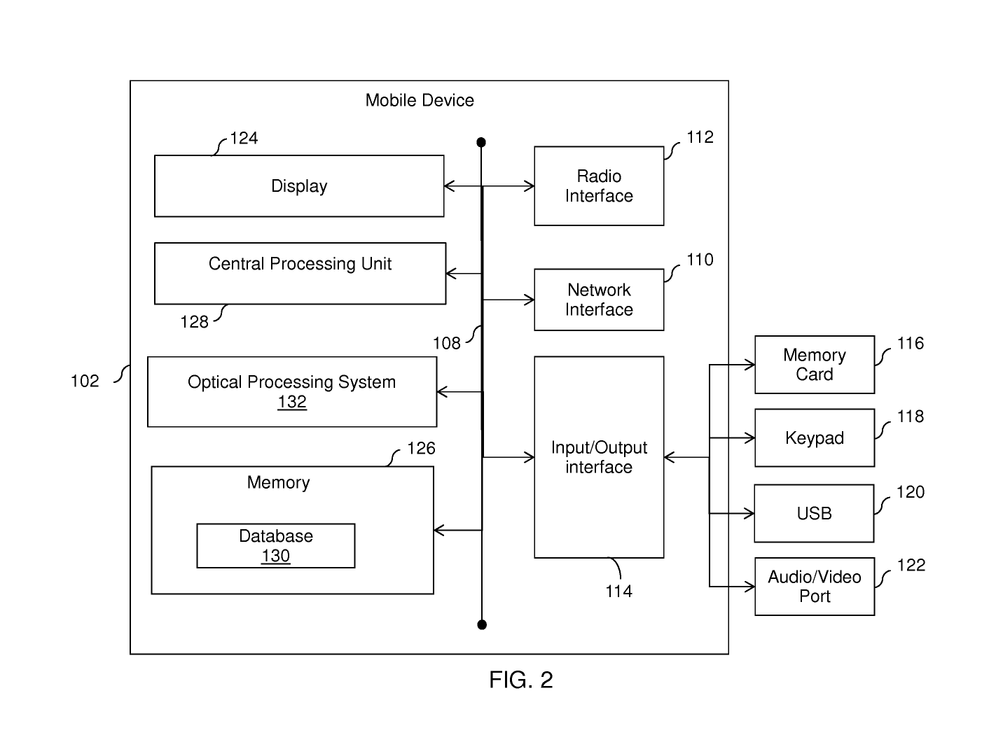

FIG. 2 illustrates an exemplary block diagram of an electronic device 102. The electronic device 102 may be connected with a network (not shown in the figure). The Network may include, but is not restricted to, a communication network such as Internet, PSTN, Local Area Network (LAN), Wide Area Network (WAN), Metropolitan Area Network (MAN), and so forth. In an embodiment, the network can be a data network such as the Internet. Further, the messages exchanged between the electronic device 102 and another electronic device over the network can comprise any suitable message format and protocol capable of communicating the information necessary for the electronic device 102.

FIG. 2 further illustrates exemplary block diagram of the electronic device 102, in accordance with an embodiment of the present invention. In an embodiment, the electronic device 102 may be utilized for communicating with another electronic device or user over the network. The electronic device 102 includes a system bus 108 to connect the various components. Examples of system bus 108 include several types of bus structures including a memory bus or memory controller, a peripheral bus, or a local bus using any of a variety of bus architectures. The electronic device 102 can be a telecommunication device such as, but not limited to, a telephone, a mobile phone, a smart-phone and so forth. The electronic device 102 may connect to the network through a network interface 110. Further, the electronic device 102 can connect to PSTN (not shown in the Figure) through a radio interface 112. Input/output (IO) interface 114 of electronic device 102 may be configured to connect external or peripheral devices such as a memory card 116, a keypad 118, a Universal Serial Bus (USB) device 120 and an audio/video port 122. Although not shown, various other devices may be connected through IO interface 114 to the electronic device 102. In an embodiment of the invention, the electronic device 102 may be connected to a hub device, which may provide various services such as voice communication, Internet access, television services and so forth. For example, the hub may be a Home Gateway device that acts as a hub between the home environment and the Broadband Network.

The electronic device 102 includes a display 124 to output graphical information to a user of the electronic device 102. In an embodiment of the invention, display 124 includes a touch sensitive screen. Therefore, the user can provide inputs to electronic device 102 by touching the display 124. Memory 126 of the electronic device 102 stores various programs, data and/or instructions that can be executed by Central Processing Unit (CPU) 128. Examples of memory include, but are not limited to, a Random Access Memory (RAM), a Read Only Memory (ROM), a hard disk, and so forth. A person skilled in the art will appreciate that other types of computer-readable media which can store data that is accessible by a computer, such as magnetic cassettes, flash memory cards, digital video disks, and the like, may also be used by electronic device 102. Memory 126 may include Operating System (OS) (not shown) for the electronic device 102 to function. Further, memory 126 may include other applications (not shown in the figure) that enable the user to perform various tasks offered by a service provider or third party. Other applications may be stored as software or firmware on the electronic device 102. Further, the memory 126 may also include a database 130 for storing various contacts or for processing various requests of the user.

The electronic device 102 further includes an optical processing system 132, according to an embodiment of the present invention. The optical processing system 132 may receive signals from the electronic device 102. In an embodiment, the signals may include, but not limited to audio signals, analog signals, RF signals and digital signals. The optical processing system 132 may further convert the received signals into optical signals. Further, the optical processing system 132 may transmit the optical signals to the earpiece 104 via an optical fiber cable 106 for conversion into sound and thereafter for use by the user.

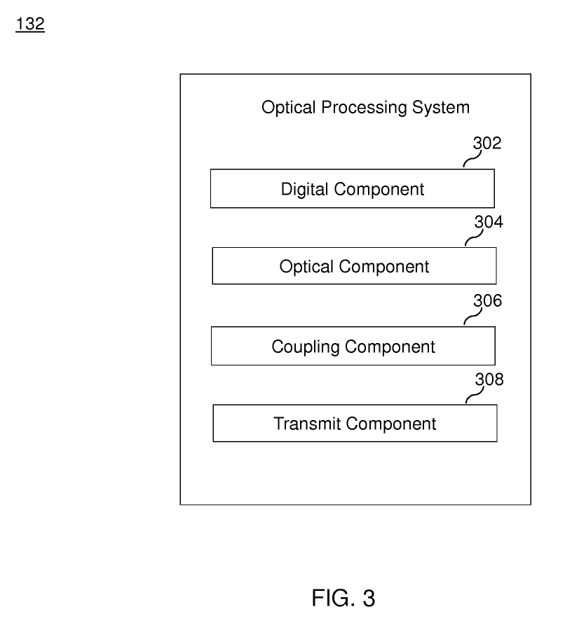

According to an embodiment of the present invention, the optical processing system 132 includes a digital component 302, an optical component 304, a coupling component 306, and a transmit component 308, as shown in FIG. 3. The digital component 302 is configured to generate digital signals based on received signals at the electronic device 102. In an embodiment of the present invention, the received signals include, but not limited to, RF signals, analog signals, audio signals, or digital signals. In case, the received signals are other than digital signals, the digital component 302 generates the digital signals based on the received signals (e.g., analog signals). In another embodiment of the present invention, the received signals may be based on a media file stored in the electronic device 102. The media file may include an audio file or video file stored in the electronic device 102.

Further, according to an embodiment of the present invention, the optical component 304 is configured to convert the digital signals into optical signals at the electronic device 102. In an embodiment of the present invention, an electrical to optical (E/O) converter may be used to convert the digital signals into optical signals and hence to generate the optical signals. In another embodiment of the present invention, the optical component may include a photodiode, phototransistor, photo-darlington pair, or the like, suitable for converting an electrical signal into a photonic signal or optical signal. In the depicted embodiment, the optical component 304 converts the electrical signal from the electronic device 102 to a photonic signal/optical signal for transmission across an optical fiber 106 to an earpiece 104.

The coupling component 306 is configured to couple the optical component with the transmit component 308. In an embodiment of the present invention, the coupling component 306 may include an optical coupler. The transmit component 308 is configured to transmit the generated optical signals to the earpiece 104. According to an embodiment of the present invention, the transmit component 308 may include a fiber optical cable 106 connecting the electronic device 102 to the earpiece 104.

The earpiece 104 (as shown in FIG. 1) may include a converter (not shown in the figure) that receives, detects, and converts the optical/photonic signal into an electrical signal. The earpiece 104 may also include an amplifier for amplifying and sending the electrical signal to a sound producing diaphragm (e.g., a speaker) for conversion to an audible impulse. The earpiece 104 may also contain a battery to supply power to the amplifier. Thus, an audio signal may be transmitted across an optical fiber 106 for eventual reproduction to an audible impulse signal corresponding to the hearing range of a user.

The earpiece 104 may further also include an audio receiver or a microphone (now shown in the figure). The microphone may include a diaphragm configured to receive and detect acoustic impulses and an actuator configured to generate an electrical signal corresponding to the acoustic impulses. The microphone may further include a converting element configured to convert electrical signals into photonic signals. The converter may comprise a photodiode, phototransistor, photo-darlington pair, or the like, suitable for converting an electrical signal into a photonic signal.

In an embodiment of the present invention, the diaphragm of the microphone may detect an acoustic impulse (e.g., voice signal), and drives an actuator to generate an electrical signal corresponding to the detected acoustic impulse. The electrical signal may be transmitted to a converting element, which then converts the electrical signal into a photonic output or optical signal. The optical signal may be subsequently transmitted over the optical fiber 106 to the electronic device 102.

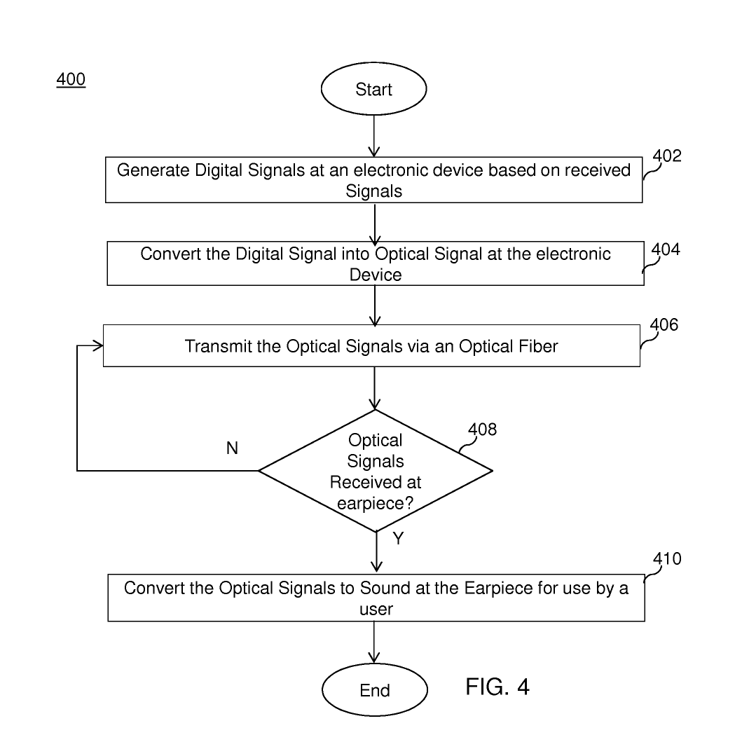

FIG. 4 is a flowchart of a method for generating optical signals at an electronic device. At step 402, digital signals are generated at an electronic device. In an embodiment of the present invention, the digital signals may be generated based upon received RF signals or analog signals at the electronic device. In another embodiment, the digital signals may be generated based upon audio or video media file stored in the electronic device. In an embodiment of the present invention, the electronic device is a mobile phone.

At step 404, the digital signals are converted into optical signals at the electronic device. In an embodiment of the present invention, an electrical to optical (E/O) converter may be used to convert the electrical signals into optical signals. In another embodiment of the present invention, a photodiode, phototransistor, photo-darlington pair, or the like, may be used for converting an electrical signal into optical signal.

At step 406, the optical signals are transmitted to an earpiece. In an embodiment of the present invention, optical signals are transmitted via an optical fiber attached to the electronic device. The optical fiber connects the electronic device with the earpiece/headset. The optical fiber cable transmits the optical signals from the electronic device to the earpiece/headset.

At step 408, it is determined whether optical signals have been received at headset. In case, the optical signals have not been received, flow of the method 400 returns at 406. Otherwise, flow of the method proceeds towards step 410.

At step 410, the received optical signals are converted to sound at the headset. In an embodiment of the present invention, the received optical signals may be first converted into electrical signals. For example, an optical to electrical (O/E) converter may convert the received optical signals to the electrical signals. Thereafter, the electrical signals may be converted to sound using a speaker. In another embodiment of the present invention, a photodiode, phototransistor, photo-darlington pair, or a similar element capable of converting an optical signal or photonic signal to an electrical signal may be utilized. The electrical signal may be amplified and then transmitted to a sound producing diaphragm or earphone capable of producing sound within the audible range of a user.

The exemplary systems and methods of this present invention have been described in relation to an electronic device. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example, in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An optical processing system for an electronic device, comprising:
a digital component configured to generate digital signals based on received signals from the electronic device;
an optical component configured to generate optical signals based on the digital signals;
a transmit component configured to transmit the generated optical signals to an earpiece, the earpiece having a laser driven diaphragm; and
an optical couple configured to couple the optical component with the transmit component, the optical coupler comprising a laser diode for actuating the diaphragm of the earpiece.

2. The optical processing system of claim 1, wherein the electronic device is a mobile phone.

3. The optical processing system of claim 1, wherein the received signals are analog signal.

4. The optical processing system of claim 1, wherein the received signals are based on a media file stored in the electronic device.

5. The optical processing system of claim 1, wherein the earpiece comprising a microphone.

6. (canceled)

7. (canceled)

8. The optical processing system of claim 1, wherein the transmit component comprising a fiber optic cable connecting the electronic device to an earpiece.

9. The optical processing system of claim 1, wherein the earpiece comprising a converter configured to convert the optical signals to sound.

10. The optical processing system of claim 9, wherein the converter comprises an optical to electrical converter and a speaker.

11. The optical processing system of claim 10, wherein the optical to electrical converter configured to convert the optical signals received into electrical signals.

12. The optical processing system of claim 11, wherein the speaker is configured to convert the electrical signals to sound.

13. A machine-implemented method for generating optical signals at an electronic device, the computer implemented method comprising:
generating digital signals based on received signals from the electronic device;
generating optical signals at the electronic device based on based on the digital signals; and
transmitting the generated optical signals to an earpiece from the electronic device
configuring an optical coupler for coupling digital signals and the transmitted optical signals, the optical coupler comprising a laser diode for actuating the diaphragm of the earpiece.

14. The machine-implemented method of claim 13, wherein the electronic device is a mobile phone.

15. The machine-implemented method of claim 13, wherein the received signals are analog signals.

16. The machine-implemented method of claim 13, wherein the received signals are based on a media file stored in a electronic device.

17. The machine-implemented method of claim 13, wherein the transmitting comprises transmitting the optical signals to the earpiece via a fiber optical cable.

18. The machine-implemented method of claim 13, wherein the earpiece converting the received optical signals into electrical signals.

19. The machine-implemented method of claim 13, wherein the earpiece further converting the electrical signals to sound.

20. The machine-implemented method of claim 13, wherein the earpiece comprising a microphone.
